(19) United States
(12) Patent Application Publication
(10) Pub. No.: US 2025/0102012 A1
(43) Pub. Date: Mar. 27, 2025

(54) MODULAR BEARING WITH REPLACEABLE, PIVOT-CONNECTED PADS

(71) Applicant: Waukesha Bearings Corporation, Waukesha, WI (US)

(72) Inventors: Filippo Cangioli, Florence (IT); Andrea Masala, Lucca (IT); Michael George Robin Gilmore, Cambuslang (GB)

(21) Appl. No.: 18/898,858

(22) Filed: Sep. 27, 2024

Related U.S. Application Data
(60) Provisional application No. 63/585,866, filed on Sep. 27, 2023.

(51) Int. Cl. F16C 17/03

(52) U.S. Cl. CPC F16C 17/03

(57) ABSTRACT

A hydrodynamic bearing for supporting a shaft includes a bearing housing and one or more pad modules. The bearing housing defines an inner surface and one or more axial grooves adjoining the inner surface. Each of at least one of the one or more pad modules includes a pad body, a root portion configured to couple in one of the axial grooves of the bearing housing, and a web portion connecting the pad body and the root portion.

### CROSS-REFERENCE TO RELATED APPLICATION

This application claims the benefit of U.S. Provisional Application 63/585,866 filed Sep. 27, 2023, the disclosure of which is incorporated herein in its entirety.

### TECHNICAL FIELD

This invention relates to bearings, and features for maintaining and cooling bearings and their components.

### BACKGROUND

Some bearings rely on a fluid film for adequate operation. The temperature of the fluid film and the temperature of the surface of a bearing can greatly affect the performance of the bearing. Bearings often encounter dynamic loads that can affect stability and increase power losses.

Hydrodynamic radial bearings are often constructed with pads supported for pivotal motion about an axis parallel to the axis of rotation of the shaft being supported. The pivoting occurs during rotation, as the fluid pressure builds at the bearing surface. In this manner, a wedge of fluid may be formed between the bearing surfaces.

### SUMMARY

Implementations of the present disclosure a hydrodynamic bearing for supporting a shaft including a bearing housing and one or more pad modules. The bearing housing defines an inner surface and one or more axial grooves adjoining the inner surface. Each of at least one of the one or more pad modules includes a pad body, a root portion configured to couple in one of the axial grooves of the bearing housing, and a web portion connecting the pad body and the root portion.

In some implementations, the web portion defines an I-beam shape.

In some implementations, at least one of the one or more pad modules is coupled to the bearing housing such that pad body is configured to tilt on an axis parallel to the axis of the shaft when the hydrodynamic bearing is installed on the shaft.

In some implementations, the bearing housing is configured to inhibit inward radial separation of the at least one pad module from the bearing housing.

In some implementations, at least one of the one or more axial grooves includes a neck portion configured to inhibit inward radial separation of the at least one pad module from the bearing housing.

In some implementations, the pad body, the web portion, and the root portion are integrally formed with one another.

In some implementations, the bearing housing includes an integral damper.

In some implementations, the web portion of the at least one pad module at least partially resides in a corresponding one of the axial grooves below the inner surface of the bearing housing.

In some implementations, at least one of the axial grooves includes a dovetail shape.

In some implementations, the root portion of at least one of the pad modules defines two or more serrations configured to inhibit inward radial separation of the at least one pad module from the bearing housing.

In some implementations, the root portion of at least one of the one or more pad modules is flared relative to the web portion.

In some implementations, the hydrodynamic bearing includes a fastener configured to couple the at least one pad module to the bearing housing.

In some implementations, the fastener inhibits axial movement along the axial groove.

In some implementations, the fastener is oriented at a slant relative to the pad module. In some implementations, the fastener is oriented in radial direction.

In some implementations, the fastener inhibits axial movement of the at least one pad module relative to the bearing housing.

In some implementations, further including a shim coupled between the root portion of the at least one pad module and the bearing housing.

In some implementations, further including one or more lubrication devices configured to supply lubricant to at least one of the one or more pad modules.

In some implementations, further including one or more directed lubrication devices configured to supply lubricant to at least one of the one or more pad modules.

In some implementations, at least one of the directed lubrication devices is integral to the bearing housing.

Further implementations of the present disclosure include a pad module for a hydrodynamic bearing including a pad body, a root portion configured to couple in an axial groove of a bearing housing, and an I-beam shaped web portion connecting the pad body and the root portion.

Further implementations of the present disclosure include a hydrodynamic bearing for supporting a shaft including a bearing housing and one or more pad modules. The bearing housing defines a first surface and one or more receptacles adjoining the first surface. Each of at least one of the one or more pad modules including a pad body, a root portion configured to couple in at least one of the receptacles of the bearing housing, and an I-beam shaped web portion connecting the pad body and the root portion.

In some implementations, the receptacle is configured to inhibit separation of the at least one pad module from the bearing housing.

In some implementations, the first surface is an inner surface. The receptacle is configured to inhibit inward radial separation of the at least one pad module from the bearing housing.

In some implementations, the hydrodynamic bearing is a tilt pad journal bearing.

In some implementations, the hydrodynamic bearing is a tilt pad thrust bearing.

In some implementations, the hydrodynamic bearing further includes one or more directed lubrication devices.

In some implementations, the hydrodynamic bearing further includes one or more lubrication devices configured to supply lubricant to a trailing edge of the at least one pad module.

Further implementations of the present disclosure include a hydrodynamic bearing including a bearing housing module, and one or more pads. The bearing housing module includes a housing body; one or more pad mount portions, and one or more I-beam shaped web portions. Each of at least one of the one or more I-beam shaped web portions connects one of the pad mount portions to the housing body. The one or more pads are coupled to each of at least one of the one or more pad mount portions.

Implementations of the present disclosure include a method of maintaining a hydrodynamic bearing that includes detaching a pad module from engagement in a receptacle of a bearing housing; and installing a root portion of a replacement pad module in the receptacle of the bearing housing such that a pad body of the replacement pad module is supported on a web portion of the pad module and such that the pad body is configured to tilt with respect to the root portion of the replacement pad module.

In some implementations, engagement of the root portion of the replacement pad module in the receptacle inhibits inward radial separation from the bearing housing.

In some implementations, the receptacle includes an axial groove, and installing replacement pad module includes sliding the replacement pad module through at least a portion of the receptacle such that the root portion engages in the axial groove.

In some implementations, the method further includes installing a fastener to secure the root portion of the replacement pad module to the bearing housing.

In some implementations, the method further includes placing a shim between the root portion of the replacement pad module and the bearing housing.

Implementation of the present disclosure further include a method of making a hydrodynamic bearing that includes positioning a pad in a bearing housing; and securing the pad to the bearing housing such that a web connecting the pad to the housing at least partially resides in a receptacle in the bearing housing.

In some implementations, the receptacle is an axial groove.

In some implementations, the web is integral to the pad.

In some implementations, the web is integral to the housing.

In some implementations, further including installing a fastener to secure a root portion of the pad to the bearing housing.

In some implementations, further including placing a shim between the pad and the bearing housing.

Further implementations of the present disclosure include a hydrodynamic bearing for supporting a shaft including a bearing housing, one or more pad modules, and one or more fasteners. The bearing housing defines one or more inner surfaces. Each of at least one of the one or more pad modules includes a pad body, a root portion including one or more axially projections, and
a pivot portion connecting the root portion with the pad portion. The one or more fasteners are configured to couple at least one of the one or more axially projections of the root portion to at least one of the one or more inner surfaces of the bearing housing.

In some implementations, the pivot portion is configured such that the pad body is tiltable relative to an axis of the bearing housing.

In some implementations, at least one of the one or more pad modules is coupled to the bearing housing such that the pad body is configured to tilt on an axis parallel to the axis of the shaft when the hydrodynamic bearing is installed on the shaft.

In some implementations, the root portion includes one or more pairs of opposing axial projections.

In some implementations, the root portion includes a base configured to receive the pivot portion.

In some implementations, the pivot portion includes a rod.

In some implementations, the pivot portion includes a web portion.

In some implementations, the pivot portion and the pad body are integrally formed with one another.

In some implementations, at least one of the one or more fasteners is installed in a radial surface of the bearing housing.

In some implementations, at least one of the one or more fasteners is installed in an axial surface of the bearing housing.

In some implementations, the bearing housing includes an integral damper.

In some implementations, the root portion of at least one of the one or more pad modules is flared relative to the web portion.

In some implementations, the hydrodynamic bearing further includes a fastener configured to couple the at least one pad module to the bearing housing.

In some implementations, the hydrodynamic bearing further includes a shim coupled between the root portion of the at least one pad module and the bearing housing.

In some implementations, the hydrodynamic bearing further includes one or more lubrication devices configured to supply lubricant to the at least one pad module.

In some implementations, the hydrodynamic bearing further includes one or more directed lubrication devices configured to direct lubricant one or more surfaces of the at least one pad module.

In some implementations, at least one of the directed lubrication devices is integral to the bearing housing.

In some implementations, the hydrodynamic bearing further includes one or more lubrication devices configured to supply lubricant to a trailing edge of the at least one pad module.

Further implementations of the present disclosure include a hydrodynamic bearing for supporting a shaft including a bearing housing and one or more pad modules. The bearing housing defining one or more inner surfaces. Each of at least one of the one or more pad modules including a pad body, a pivot portion integrally formed with the pad body, and a root portion. The pivot portion is configured such that the at least one pad body is tiltable relative to an axis of the bearing housing.

In some implementations, the root portion includes one or more pairs of opposing axial projections.

In some implementations, the hydrodynamic bearing further includes one or more fasteners configured to couple the root portion with the bearing housing.

In some implementations, the root portion includes a base configured to receive the pivot portion.

In some implementations, the pivot portion includes a rod.

In some implementations, the pivot portion includes a web portion.

In some implementations, at least one of the one or more fasteners is installed in a radial surface of the bearing housing.

In some implementations, at least one of the one or more fasteners is installed in an axial surface of the bearing housing.

In some implementations, the bearing housing includes an integral damper.

In some implementations, the root portion of at least one of the one or more pad modules is flared relative to the web portion.

In some implementations, the hydrodynamic bearing further includes a fastener configured to couple the at least one pad module to the bearing housing.

In some implementations, the hydrodynamic bearing further includes a shim coupled between the root portion of the at least one pad module and the bearing housing.

In some implementations, the hydrodynamic bearing further includes one or more lubrication devices configured to supply lubricant to the at least one pad module.

In some implementations, the hydrodynamic bearing further includes one or more directed lubrication devices configured to direct lubricant one or more surfaces of the at least one pad module.

In some implementations, at least one of the directed lubrication devices is integral to the bearing housing.

In some implementations, further including one or more lubrication devices is configured to supply lubricant to a trailing edge of the at least one pad module.

Further implementations of the present disclosure include a hydrodynamic bearing for supporting a shaft including a bearing housing and one or more pad modules. The bearing housing defines one or more inner surfaces. At least one of the pad modules including a pad and a pad support. The pad support is configured such that the pad is tiltable relative to an axis of the bearing housing. The pad support includes a base and a pivot element. The pivot element is coupled between the pad and the base.

In some implementations, the hydrodynamic bearing further includes one or more fasteners configured to couple the base with the bearing housing.

In some implementations, the base includes a pivot element-coupling portion, and one or more axial projections extending axially from the pivot element-coupling portion. At least one of the one or more fasteners is configured to couple at least one of the axial projections of the at least one pad module to the bearing housing.

In some implementations, the base includes an axial projection in each opposing axial direction from the pivot element-coupling portion. The one or more fasteners include at least one fastener configured to couple each of the opposing axial projections to the base.

In some implementations, the hydrodynamic bearing further includes a shim coupled between the base and the bearing housing.

In some implementations, the hydrodynamic bearing further includes a shim coupled between the pad and the pivot element.

In some implementations, the bearing housing includes an integral damper.

In some implementations, the hydrodynamic bearing further includes one or more lubrication devices configured to supply lubricant to the at least one pad module.

In some implementations, the hydrodynamic bearing further includes one or more directed lubrication devices configured to direct lubricant one or more surfaces of the at least one pad module.

In some implementations, at least one of the directed lubrication devices is integral to the bearing housing.

In some implementations, the hydrodynamic bearing further includes one or more lubrication devices configured to supply lubricant to a trailing edge of at least one pad module.

Particular implementations of the subject matter described in this specification can be implemented so as to realize one or more of the following advantages.

Implementations of the present disclosure may make bearing systems easier and less expensive to maintain.

Implementations of the present disclosure may increase maintainability in large bearings. For example, implementation of the present disclosure may allow some components of a bearing to be replaced without replacing other components of the bearing.

Implementations of the present disclosure may make larger bearings easier to produce.

Implementations of the present disclosure may allow different portions a bearing to be made from different materials.

Implementations of the present disclosure may improve rotodynamic behavior.

Implementations of the present disclosure may reduce pivot wear and the contact stresses, which can lead to degradation of dynamic performance.

Implementations of the present disclosure may reduce pad temperature, power loss, and pad flutter.

The details of one or more implementations of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a cross sectional view of a system including a hydrodynamic bearing with removable pad modules according to some implementations.

FIG. 2 illustrates one example of an approach for adjusting clearance on a bearing pad module.

FIG. 3 is a cross sectional view of a modular hydrodynamic bearing with a pad module having an integral web portion connected by a fastener laterally coupled to a root portion of the pad module.

FIG. 4 is a cross sectional view of a hydrodynamic bearing illustrating a pad module with an integral support element having a flared root portion.

FIG. 4A is a cross sectional detail view of a hydrodynamic bearing illustrating a shim between a pad and a pivot element.

FIG. 5 is a cross sectional view of a hydrodynamic bearing illustrating a pad module with an integral support element having a serrated root portion installed in a housing with an integrated squeeze film damper.

FIG. 6 is a cross sectional view of a hydrodynamic bearing illustrating a pad module with an integral support element coupled to a housing by way of an internal fastener.

FIG. 7A and 7B illustrate a system with a bearing housing having integral web portions that can each receive a removable pad module, according to some implementations.

FIG. 8 is an end view of a bearing having pads attached using fasteners.

FIG. 9 illustrates a bearing with pads that include projections that extend axially from a pivot.

FIG. 10 illustrates a bearing with pads with an axial length that allow the pads to tilt relative to the axis of the bearing housing.

FIG. 11 illustrates a bearing with a pad module having a pad, pivot, and base that are provided as separate components.

FIG. 12 illustrates a bearing module with a pivot held with axial fasteners.

FIG. 13 is a schematic view of a bearing that includes directed lubrication devices.

FIG. 14A is a detail front view of a directed lubrication device that is integral to a bearing housing.

FIG. 14B is a side view of the directed lubrication device of FIG. 14A looking transversely with respect to the axis of rotation of a shaft.

FIG. 15A is a front view of a spray bar that directs lubrication to an edge of a web-connected bearing.

FIG. 15B is a side view of the spray bar of FIG. 15A, looking transversely with respect to the axis of rotation of the shaft.

FIG. 16A is a front view of a pad stop that directs lubrication to an edge of a web-connected bearing.

FIG. 16B is a side view of the pad stop of FIG. 16A, looking transversely with respect to the axis of rotation of the shaft.

FIG. 16C is a top view of the pad stop of FIG. 16A.

FIG. 17 is a front schematic view of a lubrication device that directs fluid to the edges of adjacent web-connected pads.

FIG. 18 is a schematic view of a thrust bearing, according to some implementations.

### DETAILED DESCRIPTION

In various implementations, a hydrodynamic journal bearing has a modular bearing pad support system which provides flexible motion about an axis parallel to the axis of rotation of the supported shaft. The modular bearing system can include a two-piece bearing arrangement in which the pivot is integral with the pad or the pivot is integral with the bearing housing.

Applications for bearings as described herein include, but are not limited to, high-speed hydrogen energy production and wind turbines.

### Illustrative Implementations of Modular Bearing With Replaceable Pads and Integral Pad Support Elements

In some implementations, a bearing is constructed of an assembly of two basic components. The first component is a bearing pad with an integral “I” beam shaped support element. The second component is a base. In other implementations, the first component is a bearing pad and the second component is a base with two or more integral “I” beam shaped support elements. In each case, the base can be in the form of a bearing housing. The housing can include one or more segments. For example, the bearing housing can include two halves that combine to form a ring.

For purposes of describing the relationship of the components, the terms “inner” and “outer” refer to a radial direction with the innermost point being on the axis of rotation of the shaft and the outermost point being at the exterior of the bearing housing.

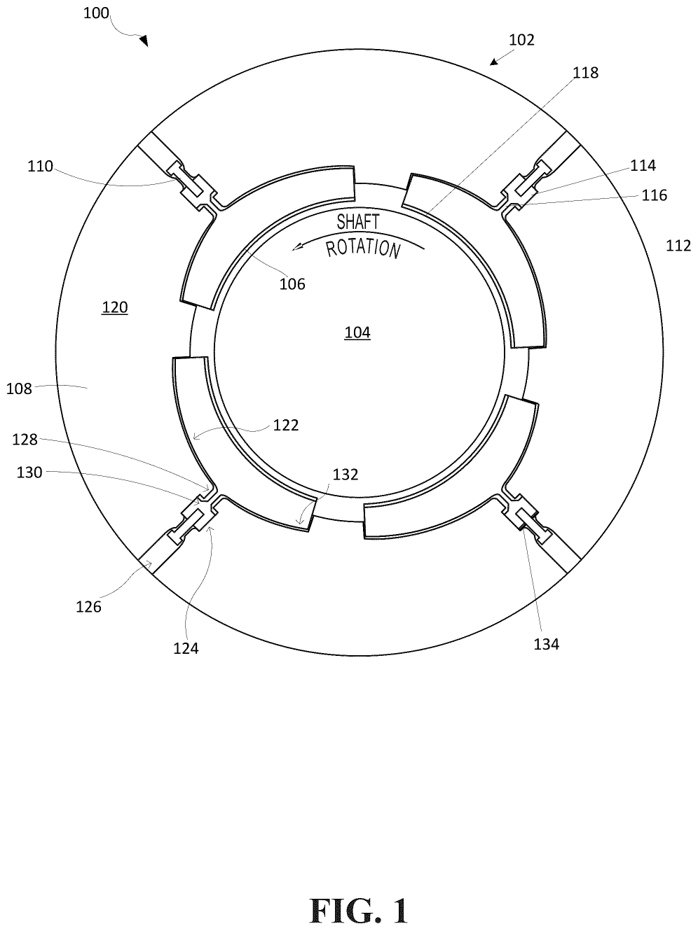

FIG. 1 is a cross sectional view of a system including a hydrodynamic bearing with removable pad modules, according to some implementations. System 100 includes bearing 102 and shaft 104. Bearing 102 supports shaft 104 as shaft 104 moves during operation of the system.

Bearing 102 includes pad modules 106 and bearing housing 108. Fasteners 110 connect each of pad modules 106 to bearing housing 110. Thus, in this example, the outer part of the I-beam shaped support element is bolted in the bearing housing using fasteners. Fasteners 110 allow the pad to be disassembled from the bearing housing for repair. In some implementations, fasteners 110 are high-strength machine screws.

Each of pad modules 106 includes a pad body portion 112, a root portion 114, and a web portion 116. Pad liner 118 is provided on the inner surface of pad body portion 112. Web portion 116 connects pad body portion 112 and root portion 114. Pad body portion 112, root portion 114, and web portion 116 can be integrally formed with one another. Pad body portion 112, web portion 116, and root portion 114 define an I-beam shaped support element.

In certain implementations, pad module 106 is formed using EDM. Pad module 106 can, however, be formed using other manufacturing techniques. For example, in one implementation, pad module 106 is formed by way of CNC milling.

Bearing housing 108 includes housing body 120. Housing body 120 includes inner radial surface 122. Axial grooves 124 in bearing housing 108 adjoin inner radial surface 112 at the location of each of pad modules 106. Each of axial grooves 124 can extend from end to end of bearing housing 108.

At each of axial grooves 124, fastener hole 126 extends from an external surface of bearing housing 108 to a corresponding one of axial grooves 124.

Each of axial grooves 124 includes a neck portion 128 and an enlarged portion 130. The enlarged portion 130 is at the distal end of the axial groove 124 relative to the inner surface of the bearing housing 108. The neck portion 128 is between the enlarged portion 130 and the inner radial surface 122 of bearing housing 108.

In the implementation shown in FIG. 1, when the pad module 106 is installed in bearing housing 108, root portion 114 of pad module 106 resides in enlarged portion 130 of axial groove 124. At least part of web portion 116 resides in neck portion 128 of axial groove 124. Engagement of root portion 114 in axial groove 124 can inhibit inward axial separation of pad module 106 from bearing housing 108. Engagement of root portion 114 can keep pad modules 106 in place before bearing 102 is installed on shaft 104 (e.g., during handling of bearing 102 and assembly of system 100).

The I-beam shaped support element that includes web portion 116 is constructed for limited flexibility about a linear axis parallel to the rotational axis of the shaft. This flexibility allows the bearing to function as a hydrodynamic bearing, namely, a bearing in which the bearing pad tilts away from the shaft at its leading edge. This arrangement may allow the formation of a wedge of lubricating fluid at the bearing surface, which converges from the leading edge to the trailing edge under the forces operating at the bearing surface.

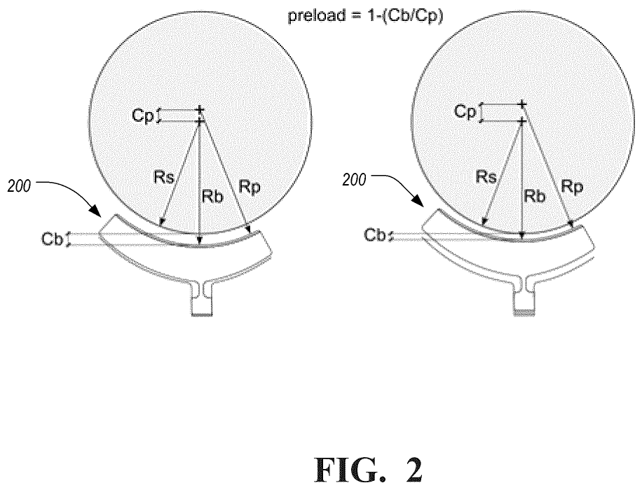

In some implementations, one or more elements are interposed between the bearing housing and pad. The elements can be selected to control aspects of bearing performance. For example, to control preload and clearance, a flat shim (see, e.g., shim 134 shown in FIG. 1) can be inserted between the outer part of the I-beam shaped support element and the bearing housing. In some implementations, the pad, pivot and/or the housing are made of different materials. The clearance can be adjusted in loco to change the dynamic characteristics of the bearing if the vibration levels of the rotating machinery are not acceptable during the commissioning. FIG. 2 illustrates one approach for adjusting clearance on a bearing pad module 200 that includes determining a preload defined by the following: preload=1−C_{b}/Cₚ).

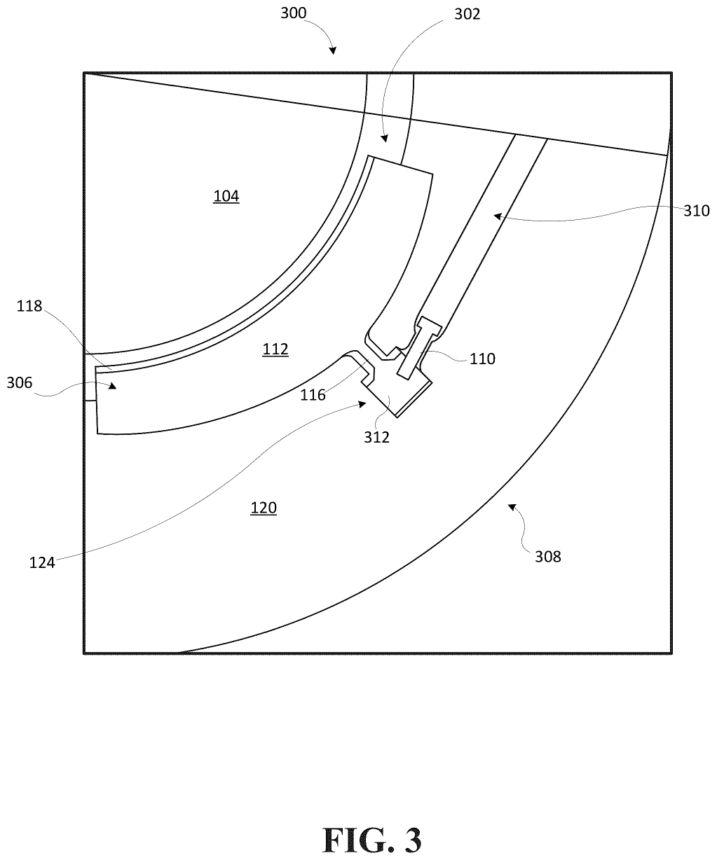

FIG. 3 is a cross sectional view of a modular hydrodynamic bearing with a pad module having an integral web portion that is connected to the bearing housing by a fastener. The fastener is laterally coupled to a root portion of the pad module. System 300 includes bearing 302 and shaft 104. Bearing 302 includes pad modules 306 and bearing housing 308. Bearing housing 308 includes fastener opening 310. Fastener 110 can be passed through fastener opening 310 and be secured to root portion 312 of pad module 302.

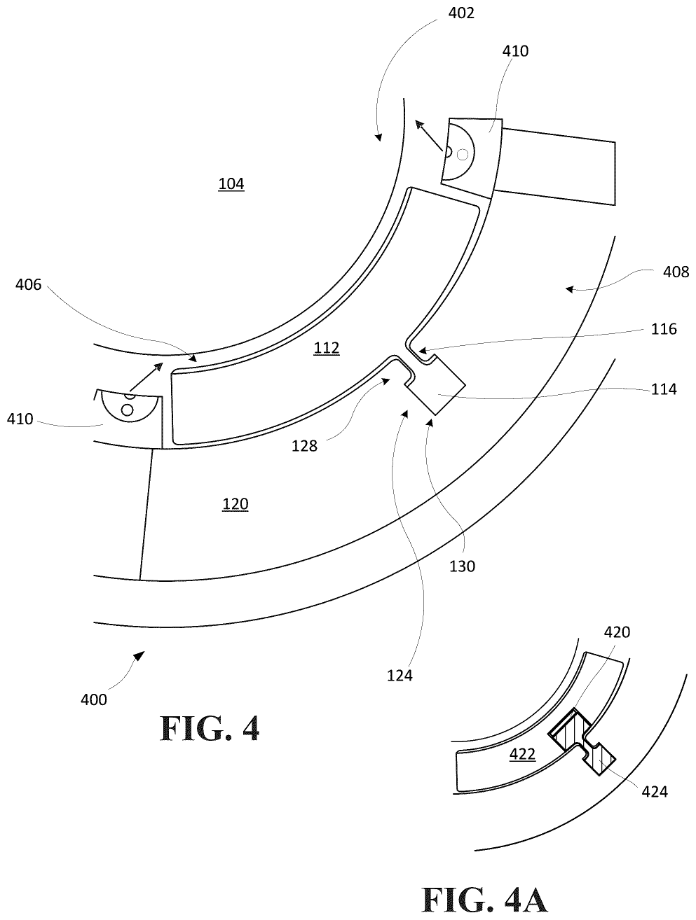

In some implementations, pad modules of a bearing are coupled in a receptacle of a bearing housing without a separate fastener. FIG. 4 is a cross sectional view of a hydrodynamic bearing illustrating a pad module with an integral support element having a flared root portion. In some implementations, axial groove 124 is a dovetail groove.

System 400 includes pad modules 406 coupled in bearing housing 408. Bearing housing 408 includes directed lubrication devices 410. Root portion 114 of pad module 406 is coupled in axial groove 124. Neck portion 128 of axial groove 124 inhibits pad module 406 from separating from bearing housing 408.

In some implementations, a shim or machine spacer is interposed between a pad and a support element. FIG. 4A illustrates a shim 420 interposed between pad 422 and pivot 424.

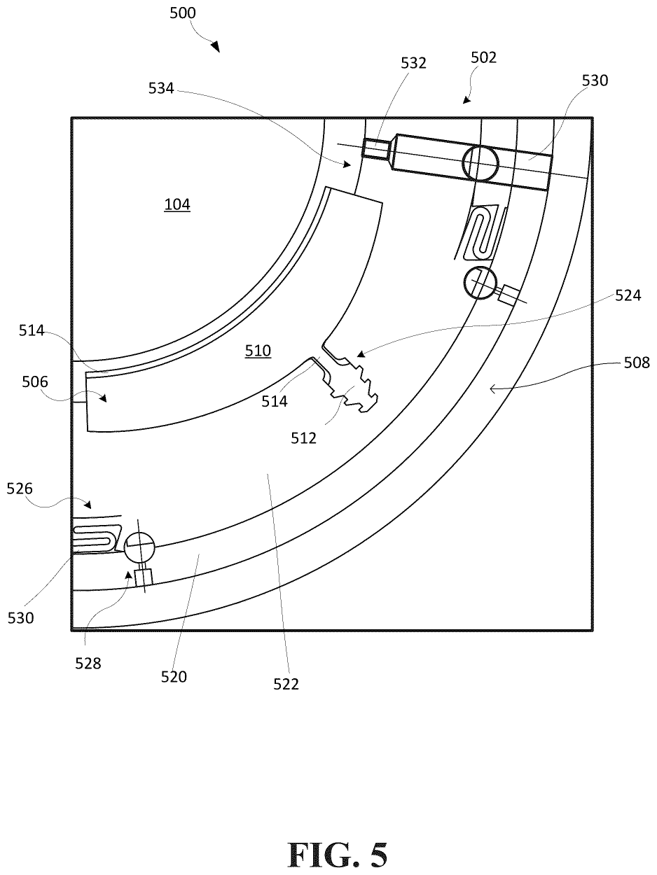

FIG. 5 is a cross sectional view of a hydrodynamic bearing illustrating a pad module with an integral support element having a serrated root portion. The pad modules are installed in a housing with an integrated squeeze film damper.

System 500 includes bearing 502 and shaft 104. Bearing 502 includes pad modules 506 and bearing housing 508. Pad modules 504 include pad body 510, root portion 512, web portion 514, and liner 518. Root portion 512 includes serrations. Bearing housing 506 includes inner housing 520, outer housing 522, axial groove 524, and integrated squeeze film damper 526. Axial groove 524 includes serrations complementary to those of root portion 512.

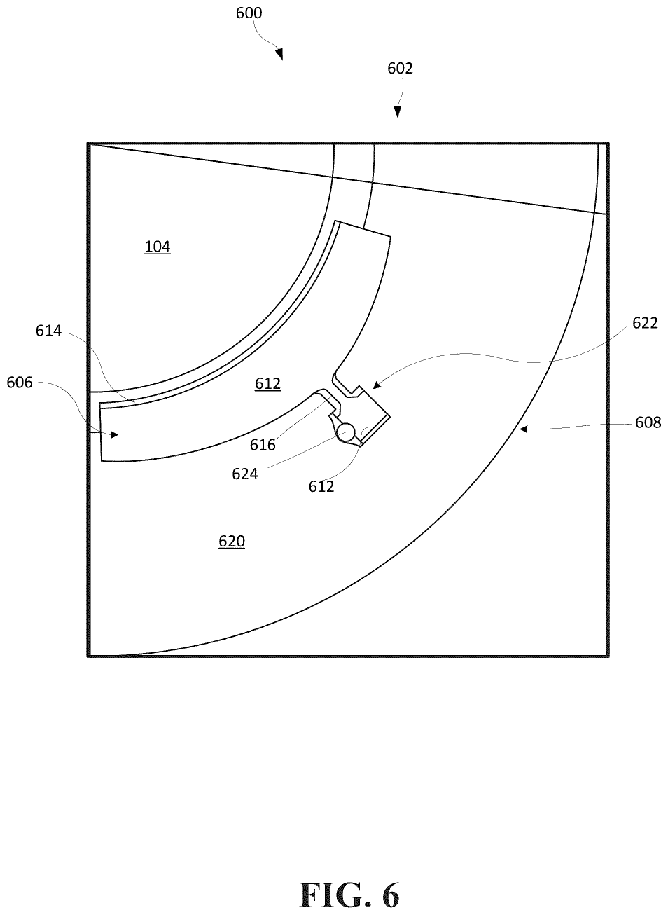

Integrated squeeze film damper 526 is integrated into bearing housing 508. The characteristics of integrated squeeze film damper 526 can be selected to control or alter the dynamic characteristics of the bearing. Integrated squeeze film damper 526 includes damper arcs 528 and “S” shaped springs 530 which generate respectively, damping and stiffness when the bearing is operating hydrodynamically. In this example, the pad can be constrained to the bearing housing with a dovetail or other geometrical shape (such as the turbine-blade root shown in FIG. 6). Use of a dovetail or other geometric shape can avoid drilling holes through the damper arc through the back of the pad.

In various implementations, a hydrodynamic bearing can be either flooded, which includes operating in a bath of oil, or it can be direct-lubricated via spray-device or oil-nozzles drilled in the bearing housing. For example, FIG. 4 illustrates spray devices in the form of directed lubrication devices 410. FIG. 5 illustrates oil-nozzles 532 drilled in bearing housing 506. Direct lubrication may reduce the power losses of the bearing, increase the load carrying capacity, and reduce pad temperature.

In some implementations, the oil-supply components or features can be designated to spray fresh oil directly to the trailing edge of the previous pad (looking opposite with respect to the direction of rotation) to cool the pad body and reduce the thermal distortion of the journal pad.

FIG. 6 is a cross sectional view of a hydrodynamic bearing illustrating a pad module with an integral support element coupled to a housing by way of an internal fastener. System 600 includes bearing 602 and shaft 104. Bearing 602 includes pad modules 606 and bearing housing 608. Pad module 606 includes pad body 612, root portion 614, web portion 616, and liner 618. Bearing housing 608 includes housing body 620 and axial groove 622. Fastener 624 secures pad module 606 to bearing housing 608.

In various implementations described above, a pad module includes an integral web portion that allows the pad body to pivot relative to a root portion of the pad module (and therefore relative to a bearing housing to which the root portion is attached). In other implementations, a pad body can, however, be separable component from the web portion. In some implementations, a web portion is integrally formed with a bearing housing.

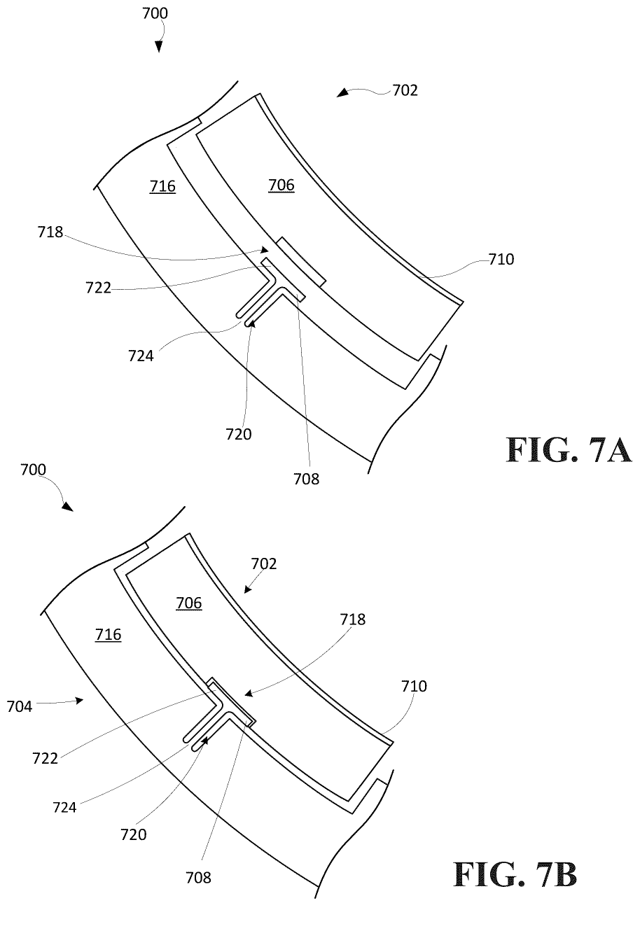

FIG. 7A and 7B illustrate a system with a bearing housing having integral web portions that can each couple with a removable pad module, according to some implementations. FIG. 7A illustrates the pad module separated from the support element. FIG. 7A illustrates the pad module installed on the support element. Bearing 700 includes pad module 602 and bearing housing 604. Pad module 602 includes pad body 606, pocket 608, and liner 610. Bearing housing 604 includes housing body 616 and support elements 718. Support elements 718 include pad mount 722 and web portion 724. Support elements 618 allow pad body 606 to pivot in an axis parallel to the axis of a shaft supported by bearing 600. In one implementation, bearing housing 604 includes four support elements 618 equally spaced about the circumference of the bearing housing. A bearing housing can, however, include any number of support elements.

In the example shown in FIG. 7, web portion 724 partially resides in gap 720. In other implementations, a pad support element integral to a bearing housing can extend radially inwardly from an inner surface of the housing.

In some implementations, a bearing is maintained by replacing one or more pad modules. For example, referring to FIG. 1, any of one of pad modules 106, including integral web portion 116, can be removed and replaced without removing any of the other pad modules 106. In implementations having support elements that are integral with the bearing housing, any of the pads can be removed from the bearing housing and replaced without removing any of the other pads or any of the support elements, and without replacing the bearing housing. For example, referring to FIG. 7, any of pad modules 702 can be removed from its support element 618 and replaced with another pad.

In certain implementations described above, pad modules are coupled in an axial grooves that extend the length of the bearing housing. In other implementations, pad modules can be coupled in a bearing housing in other forms of receptacles. For example, a pad module can include an integral support element that couples in a hole or socket in the inner surface of the housing along the length of the bearing housing. Thus, in some implementations, the receptacle that receives an integral support element of a pad module does not extend axially over the entire length of the bearing.

In some implementations, a modular pad is fixed to a bearing housing to through fasteners at the base of the pivot to the bearing housing. To make room for the screw, the length of the pivot which is responsible for the tilting of the pad may be reduced. Shims can be installed between the pivot base and the bearing housing to adjust the clearance and preload of the bearing.

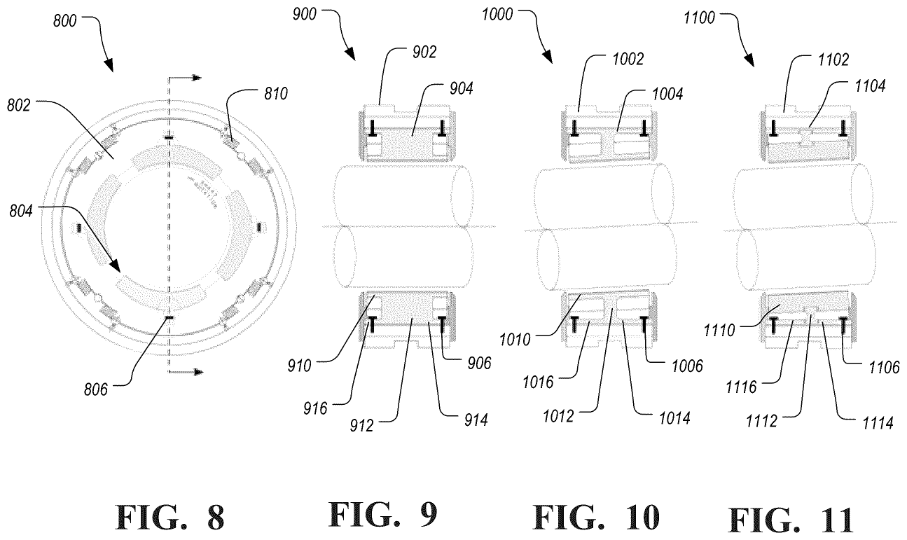

FIGS. 8, 9, 10, and 11 illustrate a hydrodynamic bearing with fasteners to attach the pads to the housing according to some implementations.

FIG. 8 is an end view of a bearing having pads attached using fasteners. Bearing 800 includes housing 802, bearing pad modules 804, and fasteners 806. Housing 802 includes integral dampers 810. Pad modules 804 are attached to housing 802 by way of fasteners 806.

FIGS. 9, 10, and 11 illustrate implementations of pad modules including a pivot. Each of the implementations FIGS. 9, 10, and 11 can be effected in a bearing similar to bearing 800 illustrated in FIG. 9.

FIG. 9 illustrates a bearing with pads that include projections that extend axially from a pivot. Bearing 900 includes housing 902, bearing pad modules 904, and fasteners 906. Bearing pad modules 904 include pad body 910, pivot 912, and root portion 914. Root portion 914 includes axial projections 916. Axial projections 916 extend axially from pivot 912 at the base of pivot 912. Pad modules 904 are attached to housing 902 by way of fasteners 906. In various implementations, axial projections 916 can be a rim, a tab, a flange, a foot, or combinations of two or more such elements. FIG. 10 illustrates a bearing with pads with an axial length that allow the pads to tilt relative to the axis of the bearing housing. Bearing 1000 includes housing 1002, bearing pad modules 1004, and fasteners 1006. Bearing pad modules 1004 include pad body 1010, pivot 1012, and root portion 1014. Root portion 1014 includes axial projections 1016. Axial projections 1016 extend axially from pivot 1012 at the base of pivot 1012.

As illustrated in FIG. 10, reducing even more the axial length of the pivot, the pad can now self-adjust its axial inclination to follow the shaft misalignment. This implementation can allow the bearing to axial align with the shaft. The axial rotational stiffness generated by the geometry of the pivot can be equal or different to the circumferential rotational stiffness of the pivot responsible for the normal tilting oaf the pad.

In some implementations, a pad module includes three parts: the pad, the pivot and the base of the pivot. The base of the pivot is connected to the bearing housing. The pivot can be separable from the pad and separable from base. For example, the pad and the base can each include a groove or socket that receives a complementary feature on the pivot.

FIG. 11 illustrates a bearing with a pad module having a pad, pivot, and base that are provided as separate components. Bearing 1100 includes housing 1102, bearing pad modules 1104, and fasteners 1106. Bearing pad modules 1104 include pad body 1110, pivot 1112, and root portion 1114. Root portion 1114 includes axial projections 1116.

In this example, root portion 1114 serves as a base for pivot 1112. Root portion 1114 form a pad support for pad body 1110. Pad body 1110 and root portion 1114 each include a groove or socket that can receive one of the opposing ends of pivot 1112. With bearing pad modules 1104 assembled and attached to housing 1102, pad body 1110 can pivot relative to the axial direction of bearing housing 1100.

In the implementations shown in FIGS. 9-11, pad modules include axial projections that extend from the pivot in opposing axial directions. In other implementations, a bearing can include pad modules with axial projections that extend in only one axial direction.

In some implementations, a pivot is in the form of a rod. In one implementation, a rod-like pivot is an independent element that connects to the housing and pad at each respective end.

The cross-section of a pivot can be elliptical, circular, rectangular, or other shape. The cross section can, in certain implementations, be selected to achieve a specific axial and circumferential rotational stiffness.

In the implementations shown in FIGS. 9-11, the pads are secured by fasteners are installed in an inner radial surface of the bearing housing. In other implementations, a bearing can include pad modules that are secured by fasteners installed in an axial direction.

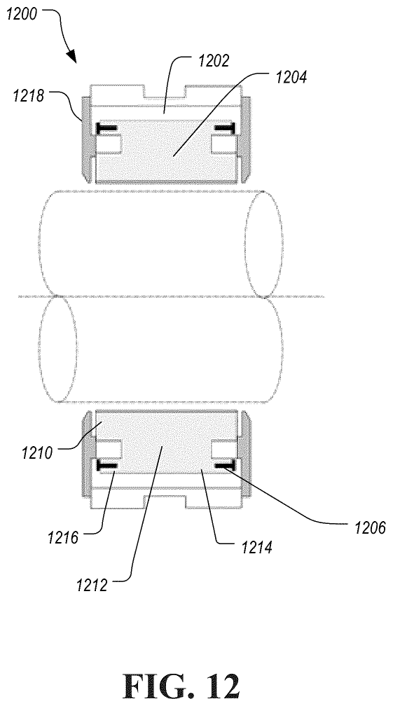

FIG. 12 illustrates a bearing module with a pivot held with axial fasteners. Bearing 1200 includes housing 1202, bearing pad modules 1204, and fasteners 1206. Bearing pad modules 1204 include pad body 1210, pivot 1212, and root portion 1214. Root portion 1214 includes axial projections 1216. Axial projections 1216 extend axially from pivot 1212 at the base of pivot 1212. Pad modules 1204 are attached to housing 1202 by way of fasteners 1206. Fasteners 1206 are installed in an axial direction. End plates 1218 can be installed on either side of bearing housing 1202.

### Illustrative Implementations With Directed Lubrication Devices

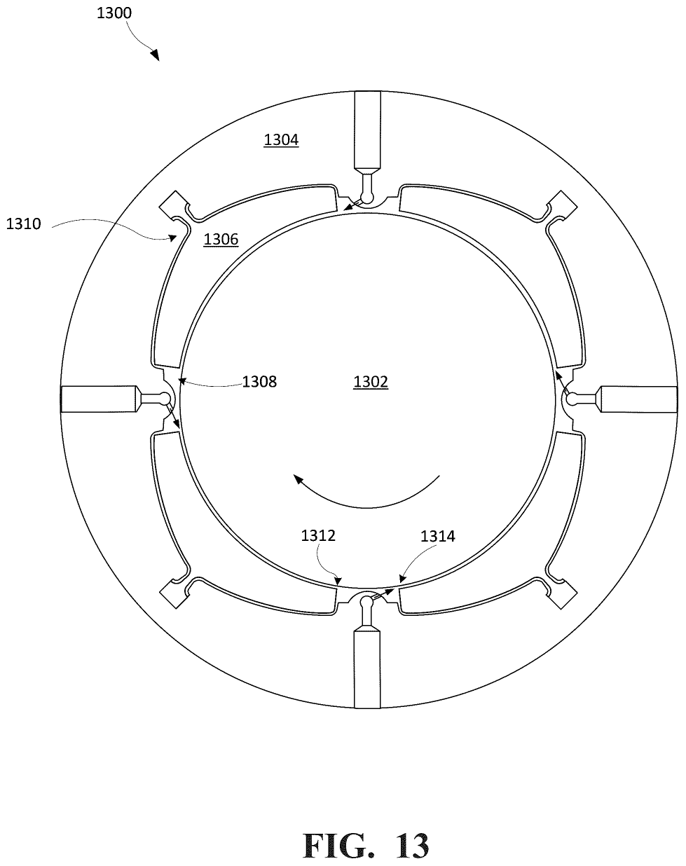

FIG. 13 is a schematic front view of a bearing for a rotating shaft including directed lubrication devices. Bearing 1300 holds rotating shaft 1302. In this example, bearing 1300 is a tilting pad journal bearing. Bearing 1300 includes bearing housing 1304, pad module 1306, and lubrication devices 1308. Each of pad modules 1306 is connected to bearing housing 1304 by way of a web 1310. In the example shown in FIG. 13, web 1310 is integral to pad module 1306. In some implementations, bearing housing 1304, pad modules 1306, lubrication devices 1308, and webs 1310 are produced using electrical discharge machining. As shaft 102 rotates, each of pad modules 106 pivots at web 1310 relative to bearing housing 1304.

Each of pad modules 1306 include a leading edge 1312 and a trailing edge 1314. In the example shown in FIG. 13, lubrication devices 1308 direct fluid toward trailing edges 1314 of pad modules 1306.

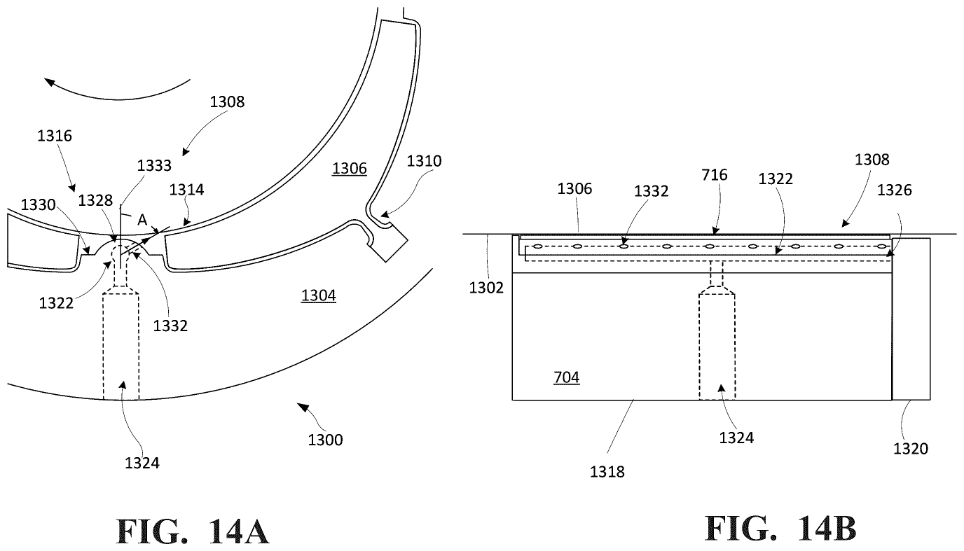

FIG. 14A is a detail front view of a directed lubrication device that is integral to a bearing housing. FIG. 14B is a side view of the directed lubrication device of FIG. 14A looking transversely with respect to the axis of rotation of the shaft. Bearing housing 1304 includes ridge 1316. Ridge 1316 protrudes from the main body 1318 of the bearing housing 1304. Housing end plate 1320 is coupled to main body 1318. Ridge 1330 runs from one end to the other of main body 1318.

Ridge 1316 includes passage 1322. Passage 1322 is in fluid communication with fluid inlet 1324. Passage 1322 includes opening 1326. Ridge 1316 includes base portion 1328 and crown portion 1330. In this example, passage 1322 can be a blind hole that runs from opening 1326 most of the full length of main body 1318.

Ridge 1316 includes a series of angled holes 1332. Angled holes 1332 can be drilled into ridge 1316. Angled holes 1332 are in fluid communication with passage 1322. Passage 1322 can serve as a manifold for distributing lubrication fluid to angled holes 1332. Lubricating fluid can be introduced through fluid inlet 1324, through passage 1322, and through angled holes 1332. Angled holes 1332 can direct fluid toward an edge of one or more of pad modules 1306 (in example shown in FIG. 3A, toward trailing edge 1314 of pad module 1306).

In IG. 14A, angle A represents the angle between angled holes 1332 and a radial direction 1333 of bearing 1300. In some implementations, angle A is between about 40 and 70 degrees. In one implementation, angle A is 50 plus or minus 5 degrees. In certain implementations, angle A varies across the width of the bearing. For example, the angle can be more or less near the edges of bearing housing 1304 than near the middle of bearing housing 1304. In some implementations, holes are spaced evenly across the width of the bearing. In other implementations, the spacing between holes varies across the width of bearing 1300.

Lubrication devices 1308 can direct fluid toward the edges of pad modules 1306. In certain implementations, lubrication devices 1308 direct fluid toward the trailing or leading faces of pad modules 1306. Each lubrication device includes apertures (e.g., angled holes 1332) that can direct fluid from a fluid inlet outward with specific fluid flow characteristics (e.g., velocity, flow rate). In certain implementations, a lubrication device includes one set of apertures that remove existing fluid from the pads and another set of apertures that provide fresh fluid to the pads.

Examples of bearing materials that can be used in bearings as described herein include steel, aluminum tin, copper, copper chrome, bronze, babbitt, aluminum tin, ceramic, polymer, polycrystalline diamond (PCD), and tungsten carbide. In some cases, bearings are babbitt-lined.

In one implementation, clearance between the active surface of each pad and the shaft 702 is about 0.05 mm. In one example, pad is about 200 mm thick in the radial dimension and 520 mm in the axial dimension.

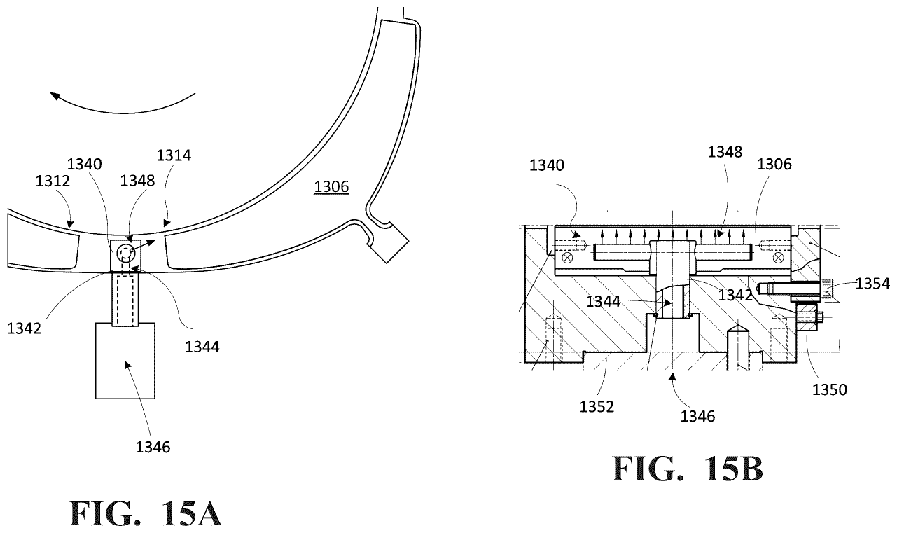

In the example shown in FIGS. 13, 14A, and 14B, lubrication device for directing fluid is integral with the bearing housing. In other implementations, lubrication devices of a bearing include components separate from the bearing housing for directing fluid to one or more edges of web-connected pads of a bearing. FIG. 15A is a front view of a spray bar that directs lubrication to an edge of a web-connected bearing. FIG. 15B is a side view of the spray bar of FIG. 15A looking transversely with respect to the axis of rotation of a shaft. Spray bar 1340 is at a distal end of base 1342. Passages 1344 in base 1342 and spray bar 1340 carry fluid from fluid inlet 1346 to apertures 1348 in spray bar 1340 and base 1342. Fluid is directed to trailing edge 1314 of pad module 1306. Housing end plate 1350 is coupled to housing main body 1352 by way of fasteners 1354.

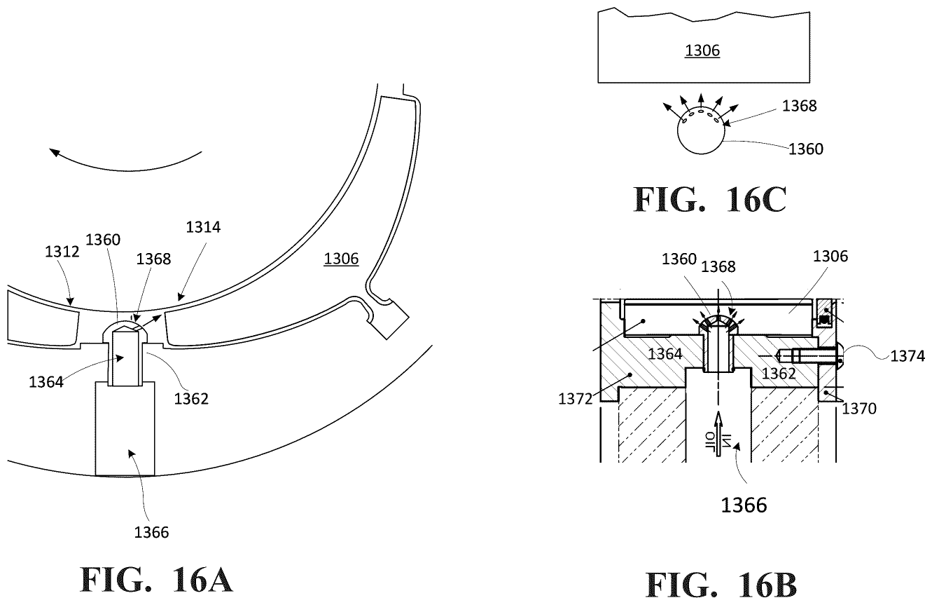

FIG. 16A is a front view of a pad stop that directs lubrication to an edge of a web-connected bearing. FIG. 16B is a side view of the pad stop of FIG. 16A looking transversely with respect to the axis of rotation of a shaft. Pad stop 1360 is at a distal end of base 1362. Passage 1364 in base 1362 and pad stop 1360 carry fluid from fluid inlet 1366 to apertures 1368 in pad stop 1360. Fluid is directed to trailing edge 1314 of pad 1306. Housing end plate 1370 is coupled to housing main body 1372 by way of fasteners 1374.

Referring to FIG. 16C, apertures 1368 in pad stop 1360 can be arranged radially with respect to a centerline of pad stop 1360. In some implementations, apertures 1368 are angularly spaced equally from one another. The spacing of apertures 1368 can nevertheless differ around the circumference of the pad stop in various implementations.

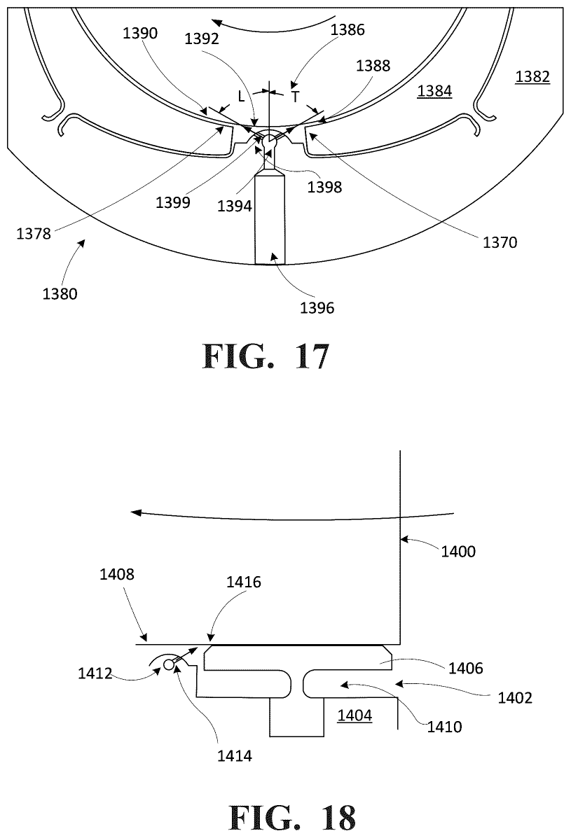

In some implementations, a lubrication device directs a fluid to more than one pad of a bearing. FIG. 17 is a front schematic view of a lubrication device that directs fluid to the edges of adjacent web-connected pads. Bearing 1380 includes bearing housing 1382, pads 1384, and lubrication device 1386. Each of pads 1384 is connected to bearing housing 1384 by way of a web 1386. Each of pads 1384 include a trailing edge 1378 and a leading edge 1370.

Lubrication device 1386 includes ridge 1392. Ridge 1392 includes passage 1394. Passage 1394 is in fluid communication with fluid inlet 1396. Ridge 1396 includes a series of angled holes 1398, 1399. Angled holes 1398, 1399 can be drilled into ridge 1396. Angled holes 1398, 1399 are in fluid communication with passage 1394. Passage 1394 can serve as a manifold for distributing lubrication fluid to angled holes 1398, 1399. Lubricating fluid can be introduced through fluid inlet 1396, through passage 1394, and then through angled holes 1398, 1399. Angled holes 1398 can direct fluid toward trailing edge 1378. Angled holes 799 can direct fluid to leading edge 790.

The number, arrangement, angle, spacing, and size can vary from implementation to implementation. In one example of the bearing shown in FIG. 17, for example, the number, arrangement, angle, spacing, and size is the same for angled holes 1398 and angled holes 1399. Angled holes 1399 for the leading edge 1390 can, however, be smaller, fewer in number, or at a different angle relative to a radial direction than angled holes 1398 for trailing edge 1378. In some implementations, angle T is the same as angle L. In other implementations, angle T is different than angle L. In one implementation, angles L and T are between about 40 and 70 degrees.

In the examples shown in FIGS. 13 through 17, one lubrication device is included between each adjacent pair of pads. Each lubrication device can direct lubrication in one direction or more than one direction. In some implementations, a bearing includes two or more lubrication devices between adjacent pads. In certain implementations, a bearing housing includes a separate ridge, spray bar, or pad stop for each of the leading and trailing edges of adjacent pads.

In various implementations described above, directed lubrication devices are provided in a bearing having pad modules with integral support elements that are removable from a housing, or housings with integral support elements to which removable pads can be coupled. In other implementations, however, the pads, housing, and connecting webs can all be integral with one another (see, for example, FIG. 17). Thus, in certain implementations, a bearing can be formed as one piece, such as by EDM.

In various implementations described above with respect to FIGS. 1 through 17, modular pads and/or lubrication devices are included in a journal bearing. In other implementations, modular, web-connected pads and/or lubrication devices are included in other types of bearings. FIG. 18 is a schematic view of a thrust bearing according to one example. Shaft 1400 is supported on thrust bearing 1402. Thrust bearing 1402 includes bearing housing 1404, pad modules 1406, and lubrication device 1408 (for clarity, only one pad 1406 is shown in FIG. 18). Pads modules 1406 are coupled to bearing housing 1404 by way of web 1410. In this example, web 1410 is integral to pad module 1406. Shaft 1400 rotates on pads 1406. In one implementation, thrust bearing 1402 includes five pads equally spaced around the circumference of bearing housing 1404.

Lubrication device 1408 includes passage 1412 and holes 1414. Fluid is delivered to passage 1412 and directed through holes 1414 to an edge 1416 of pad 1406. In one implementation, edge 1416 is a trailing edge of pad 1406.

In various implementations described herein, pads are connected to a bearing housing by way of a web. In certain implementations, pads can be coupled by other types of pivot elements. Examples of alternate pivot types include ball and socket, point contact, and line contact.

In various implementations described above, the bearing includes four pads. A bearing can nevertheless have, in various implementations, any number of pads. In one implementation, a journal bearing includes five web-connected pads.

Although the disclosed inventive concepts include those defined in the attached claims, it should be understood that the inventive concepts can also be defined in accordance with the following embodiments.

Embodiment 1 is a hydrodynamic bearing for supporting a shaft, the hydrodynamic bearing comprising: a bearing housing defining an inner surface and one or more axial grooves adjoining the inner surface; and one or more pad modules, each of at least one of the one or more pad modules comprising: a pad body; a root portion configured to couple in one of the axial grooves of the bearing housing; and a web portion connecting the pad body and the root portion.

Embodiment 2 is the hydrodynamic bearing of embodiment 1, wherein the web portion defines an I-beam shape.

Embodiment 3 is the hydrodynamic bearing of embodiment 1 or embodiment 2, wherein at least one of the one or more pad modules is coupled to the bearing housing such that pad body is configured to tilt on an axis parallel to the axis of the shaft when the hydrodynamic bearing is installed on the shaft.

Embodiment 4 is the hydrodynamic bearing of any one of embodiments 1 through 3, wherein the bearing housing is configured to inhibit inward radial separation of the at least one pad module from the bearing housing.

Embodiment 5 is the hydrodynamic bearing of any one of embodiments 1 through 4, wherein at least one of the one or more axial grooves comprises a neck portion configured to inhibit inward radial separation of the at least one pad module from the bearing housing.

Embodiment 6 is the hydrodynamic bearing of any one of embodiments 1 through 5, wherein the pad body, the web portion, and the root portion are integrally formed with one another.

Embodiment 7 is the hydrodynamic bearing of any one of embodiments 1 through 6, wherein the bearing housing comprises an integral damper.

Embodiment 8 is the hydrodynamic bearing of any one of embodiments 1 through 7, wherein the web portion of the at least one pad module at least partially resides in a corresponding one of the axial grooves below the inner surface of the bearing housing.

Embodiment 9 is the hydrodynamic bearing of any one of embodiments 1 through 8, wherein at least one of the axial grooves comprises a dovetail shape.

Embodiment 10 is the hydrodynamic bearing of any one of embodiments 1 through 9, wherein the root portion of at least one of the pad modules defines two or more serrations configured to inhibit inward radial separation of the at least one pad module from the bearing housing.

Embodiment 11 is the hydrodynamic bearing of any one of embodiments 1 through 10, wherein the root portion of at least one or more pad modules is flared relative to the web portion.

Embodiment 12 is the hydrodynamic bearing of any one of embodiments 1 through 11, further comprising a fastener configured to couple the at least one pad module to the bearing housing.

Embodiment 13 is the hydrodynamic bearing of embodiment 12, wherein the fastener inhibits axial movement along the axial groove.

Embodiment 14 is the hydrodynamic bearing of embodiment 12, wherein the fastener is oriented at a slant relative to the pad module.

Embodiment 15 is the hydrodynamic bearing of embodiment 12, wherein the fastener is oriented in a radial direction.

Embodiment 16 is the hydrodynamic bearing of embodiment 12, wherein the fastener inhibits axial movement of the at least one pad module relative to the bearing housing.

Embodiment 17 is the hydrodynamic bearing of any one of embodiments 1 through 16, further comprising a shim coupled between the root portion of the at least one pad module and the bearing housing.

Embodiment 18 is the hydrodynamic bearing of any one of embodiments 1 through 17, further comprising one or more lubrication devices configured to supply lubricant to at least one of the one or more pad modules.

Embodiment 19 is the hydrodynamic bearing of any one of embodiments 1 through 18, further comprising one or more directed lubrication devices configured to supply lubricant to at least on of the one or more pad modules.

Embodiment 20 is the hydrodynamic bearing of embodiment 19, wherein at least one of the directed lubrication devices is integral to the bearing housing.

Embodiment 21 is a pad module for a hydrodynamic bearing, the hydrodynamic bearing comprising: a pad body; a root portion configured to couple in an axial groove of a bearing housing; and an I-beam shaped web portion connecting the pad body and the root portion.

Embodiment 22 is a hydrodynamic bearing for supporting a shaft, the hydrodynamic bearing comprising: a bearing housing defining a first surface and one or more receptacles adjoining the first surface; and one or more pad modules, each of at least one of the one or more pad modules comprising: a pad body; a root portion configured to couple in at least one of the receptacles of the bearing housing; and an I-beam shaped web portion connecting the pad body and the root portion.

Embodiment 23 is the hydrodynamic bearing of embodiment 22, wherein the at least one of the receptacles is configured to inhibit separation of the at least one pad module from the bearing housing.

Embodiment 24 is the hydrodynamic bearing of embodiment 22 or embodiment 23, wherein: the first surface is an inner surface; and the at least one of the receptacles is configured to inhibit inward radial separation of the at least one pad module from the bearing housing.

Embodiment 25 is the hydrodynamic bearing of any one of embodiments 22 through 24, wherein the hydrodynamic bearing is a tilt pad journal bearing.

Embodiment 26 is the hydrodynamic bearing of any one of embodiments 22 through 24, wherein the hydrodynamic bearing is a tilt pad thrust bearing.

Embodiment 27 is the hydrodynamic bearing of any one of embodiments 22 through 26, further comprising one or more directed lubrication devices.

Embodiment 28 is the hydrodynamic bearing of any one of embodiments 22 through 26, further comprising one or more lubrication devices configured to supply lubricant to a trailing edge of the at least one pad module.

Embodiment 29 is a hydrodynamic bearing, comprising: a bearing housing module comprising: a housing body; one or more pad mount portions; and one or more I-beam shaped web portions, each of at least one of the one or more I-beam shaped web portions connecting one of the pad mount portions to the housing body; and one or more pads coupled to each of at least one of the one or more pad mount portions.

Embodiment 30 is a method of maintaining a hydrodynamic bearing, the method comprising: detaching a pad module from engagement in a receptacle of a bearing housing; and installing a root portion of a replacement pad module in the receptacle of the bearing housing such that a pad body of the replacement pad module is supported on a web portion of the pad module and such that the pad body is configured to tilt with respect to the root portion of the replacement pad module.

Embodiment 31 is the method of embodiment 30, wherein engagement of the root portion of the replacement pad module in the receptacle inhibits inward radial separation from the bearing housing.

Embodiment 32 is the method of embodiment 30 or embodiment 31, wherein: the receptacle comprises an axial groove; and installing replacement pad module comprises sliding the replacement pad module through at least a portion of the receptacle such that the root portion engages in the axial groove.

Embodiment 33 is the method of any one of embodiments 30 through 32, further comprising installing a fastener to secure the root portion of the replacement pad module to the bearing housing.

Embodiment 34 is the method of any one of embodiments 31 through 33, further comprising placing a shim between the root portion of the replacement pad module and the bearing housing.

Embodiment 35 is a method of making a hydrodynamic bearing, the method comprising: positioning a pad in a bearing housing; and securing the pad to the bearing housing such that a web connecting the pad to the housing at least partially resides in a receptacle in the

Embodiment 36 is the method of embodiment 35, wherein the receptacle is an axial groove.

Embodiment 37 is the method of embodiment 35 or embodiment 36, wherein the web is integral to the pad.

Embodiment 38 is the method of any one of embodiments 35 through 37, wherein the web is integral to the housing.

Embodiment 39 is the method of any one of embodiments 35 through 38, further comprising installing a fastener to secure a root portion of the pad to the bearing housing.

Embodiment 40 is the method of any one of embodiments 35 through 39, further comprising placing a shim between the pad and the bearing housing.

Embodiment 41 is a hydrodynamic bearing for supporting a shaft, the hydrodynamic bearing comprising: a bearing housing defining one or more inner surfaces; one or more pad modules, each of at least one of the one or more pad modules comprising: a pad body; a root portion comprising one or more axially projections; and a pivot portion connecting the root portion with the pad portion; and one or more fasteners configured to couple at least one of the one or more axially projections of the root portion to at least one of the one or more inner surfaces of the bearing housing.

Embodiment 42 is the hydrodynamic bearing of embodiment 41, wherein the pivot portion is configured such that the pad body is tiltable relative to an axis of the bearing housing.

Embodiment 43 is the hydrodynamic bearing of embodiment 41 or embodiment 42, wherein at least one of the one or more pad modules is coupled to the bearing housing such that the pad body is configured to tilt on an axis parallel to the axis of the shaft when the hydrodynamic bearing is installed on the shaft.

Embodiment 44 is the hydrodynamic bearing of any one of embodiments 41 through 43, wherein the root portion comprises one or more pairs of opposing axial projections.

Embodiment 45 is the hydrodynamic bearing of any one of embodiments 41 through 44, wherein the root portion comprises a base configured to receive the pivot portion.

Embodiment 46 is the hydrodynamic bearing of any one of embodiments 41 through 45, wherein the pivot portion comprises a rod.

Embodiment 47 is the hydrodynamic bearing of any one of embodiments 41 through 46, wherein the pivot portion comprises a web portion.

Embodiment 48 is the hydrodynamic bearing of any one of embodiments 41 through 47, wherein the pivot portion and the pad body are integrally formed with one another.

Embodiment 49 is the hydrodynamic bearing of any one of embodiments 41 through 48, wherein at least one of the one or more fasteners is installed in a radial surface of the bearing housing.

Embodiment 50 is the hydrodynamic bearing of any one of embodiments 41 through 49, wherein at least one of the one or more fasteners is installed in an axial surface of the bearing housing.

Embodiment 51 is the hydrodynamic bearing of any one of embodiments 41 through 50, wherein the bearing housing comprises an integral damper.

Embodiment 52 is the hydrodynamic bearing of any one of embodiments 41 through 51, wherein the root portion of at least one of the one or more pad modules is flared relative to the web portion.

Embodiment 53 is the hydrodynamic bearing of any one of embodiments 41 through 52, further comprising a fastener configured to couple the at least one pad module to the bearing housing.

Embodiment 54 is the hydrodynamic bearing of any one of embodiments 41 through 54, further comprising a shim coupled between the root portion of the at least one pad module and the bearing housing.

Embodiment 55 is the hydrodynamic bearing of any one of embodiments 41 through 54, further comprising one or more lubrication devices configured to supply lubricant to the at least one pad module.

Embodiment 56 is the hydrodynamic bearing of any one of embodiments 41 through 55, further comprising one or more directed lubrication devices configured to direct lubricant to one or more surfaces of the at least one pad module.

Embodiment 57 is the hydrodynamic bearing of embodiment 56, wherein at least one of the directed lubrication devices is integral to the bearing housing.

Embodiment 58 is the hydrodynamic bearing of any one of embodiments 41 through 57, further comprising one or more lubrication devices configured to supply lubricant to a trailing edge of the at least one pad module.

Embodiment 59 is a hydrodynamic bearing for supporting a shaft, the hydrodynamic bearing comprising: a bearing housing defining one or more inner surfaces; one or more pad modules, each of at least one of the one or more pad modules comprising: a pad body; a pivot portion integrally formed with the pad body; and a root portion; wherein the pivot portion is configured such that the at least one pad body is tiltable relative to an axis of the bearing housing.

Embodiment 60 is the hydrodynamic bearing of embodiment 59, wherein the root portion comprises one or more pairs of opposing axial projections.

Embodiment 61 is the hydrodynamic bearing of embodiment 59 or embodiment 60, further comprising one or more fasteners configured to couple the root portion with the bearing housing.

Embodiment 62 is the hydrodynamic bearing of any one of embodiments 59 through 61, wherein the root portion comprises a base configured to receive the pivot portion.

Embodiment 63 is the hydrodynamic bearing of any one of embodiments 59 through 62, wherein the pivot portion comprises a rod.

Embodiment 64 is the hydrodynamic bearing of any one of embodiments 59 through 63, wherein the pivot portion comprises a web portion.

Embodiment 65 is the hydrodynamic bearing of any one of embodiments 59 through 64, wherein at least one of the one or more fasteners is installed in a radial surface of the bearing housing.

Embodiment 66 is the hydrodynamic bearing of any one of embodiments 59 through 65, wherein at least one of the one or more fasteners is installed in an axial surface of the bearing housing.

Embodiment 67 is the hydrodynamic bearing of any one of embodiments 59 through 66, wherein the bearing housing comprises an integral damper.

Embodiment 68 is the hydrodynamic bearing of any one of embodiments 59 through 67, wherein the root portion of at least one of the one or more pad modules is flared relative to the web portion.

Embodiment 69 is the hydrodynamic bearing of any one of embodiments 59 through 68, further comprising a fastener configured to couple the at least one pad module to the

Embodiment 70 is the hydrodynamic bearing of any one of embodiments 59 through 69, further comprising a shim coupled between the root portion of the at least one pad module and the bearing housing.

Embodiment 71 is the hydrodynamic bearing of any one of embodiments 59 through 70, further comprising one or more lubrication devices configured to supply lubricant to the at least one pad module.

Embodiment 72 is the hydrodynamic bearing of any one of embodiments 59 through 71, further comprising one or more directed lubrication devices configured to direct lubricant to one or more surfaces of the at least one pad module.

Embodiment 73 is the hydrodynamic bearing of embodiment 72, wherein at least one of the directed lubrication devices is integral to the bearing housing.

Embodiment 74 is the hydrodynamic bearing of embodiment 73, further comprising one or more lubrication devices configured to supply lubricant to a trailing edge of the at least one pad module.

Embodiment 75 is a hydrodynamic bearing for supporting a shaft, the hydrodynamic bearing comprising: a bearing housing defining one or more inner surfaces; one or more pad modules, at least one of the pad modules comprising: a pad; and a pad support configured such that the pad is tiltable relative to an axis of the bearing housing, the pad support comprising: a base; and a pivot element coupled between the pad and the base.

Embodiment 76 is the hydrodynamic bearing of embodiment 75, further comprising one or more fasteners configured to couple the base with the bearing housing.

Embodiment 77 is the hydrodynamic bearing of embodiment 75 or embodiment 76, wherein: the base comprises: a pivot element-coupling portion; and one or more axial projections extending axially from the pivot element-coupling portion, and at least one of the one or more fasteners is configured to couple at least one of the axial projections of the at least one pad module to the bearing housing.

Embodiment 78 is the hydrodynamic bearing of any one of embodiments 75 through 77, wherein the base comprises an axial projection in each opposing axial direction from the pivot element-coupling portion, and wherein the one or more fasteners comprise at least one fastener configured to couple each of the opposing axial projections to the base.

Embodiment 79 is the hydrodynamic bearing of any one of embodiments 75 through 78, further comprising a shim coupled between the base and the bearing housing.

Embodiment 80 is the hydrodynamic bearing of any one of embodiments 75 through 79, further comprising a shim coupled between the pad and the pivot element.

Embodiment 81 is the hydrodynamic bearing of any one of embodiments 75 through 80, wherein the bearing housing comprises an integral damper.

Embodiment 82 is the hydrodynamic bearing of any one of embodiments 75 through 81, further comprising one or more lubrication devices configured to supply lubricant to the at least one pad module.

Embodiment 83 is the hydrodynamic bearing of any one of embodiments 75 through 82, further comprising one or more directed lubrication devices configured to direct lubricant to one or more surfaces of the at least one pad module.

Embodiment 84 is the hydrodynamic bearing of embodiment 83, wherein at least one of the directed lubrication devices is integral to the bearing housing.

Embodiment 85 is the hydrodynamic bearing of any one of embodiments 75 through 84, further comprising one or more lubrication devices configured to supply lubricant to a trailing edge of the at least one pad module.

Particular implementations of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example implementations do not define or constrain this disclosure. Other changes, substitutions, and alterations are also possible without departing from the spirit and scope of this disclosure.

What is claimed is:

1. A hydrodynamic bearing for supporting a shaft, the hydrodynamic bearing comprising:
a bearing housing defining an inner surface and one or more axial grooves adjoining the inner surface; and
one or more pad modules, each of at least one of the one or more pad modules comprising:
a pad body;
a root portion configured to couple in one of the axial grooves of the bearing housing; and
a web portion connecting the pad body and the root portion.

2. The hydrodynamic bearing of claim 1, wherein the web portion defines an I-beam shape.

3. The hydrodynamic bearing of claim 1, wherein at least one of the one or more pad modules is coupled to the bearing housing such that the pad body is configured to tilt on an axis parallel to the axis of the shaft when the hydrodynamic bearing is installed on the shaft.

4. The hydrodynamic bearing of claim 1, wherein the bearing housing is configured to inhibit inward radial separation of the at least one pad module from the bearing housing.

5. The hydrodynamic bearing of claim 1, wherein at least one of the one or more axial grooves comprises a neck portion configured to inhibit inward radial separation of the at least one pad module from the bearing housing.

6. The hydrodynamic bearing of claim 1, wherein the pad body, the web portion, and the root portion are integrally formed with one another.

7. The hydrodynamic bearing of claim 1, wherein the bearing housing comprises an integral damper.

8. The hydrodynamic bearing of claim 1, wherein the web portion of the at least one pad module at least partially resides in a corresponding one of the axial grooves below the inner surface of the bearing housing.

9. The hydrodynamic bearing of claim 1, wherein at least one of the axial grooves comprises a dovetail shape.

10. The hydrodynamic bearing of claim 1, wherein the root portion of at least one of the pad modules defines two or more serrations configured to inhibit inward radial separation of the at least one pad module from the bearing housing.

11. The hydrodynamic bearing of claim 1, wherein the root portion of at least one of the one or more pad modules is flared relative to the web portion.

12. The hydrodynamic bearing of claim 1, further comprising a fastener configured to couple the at least one pad module to the bearing housing, wherein the fastener inhibits axial movement along the axial groove, and wherein the fastener is oriented at a slant relative to the pad module.

13. The hydrodynamic bearing of claim 1, further comprising a shim coupled between the root portion of the at least one pad module and the bearing housing.

14. The hydrodynamic bearing of claim 1, further comprising one or more lubrication devices configured to supply lubricant to at least one of the one or more pad modules.

15. A method of making a hydrodynamic bearing, the method comprising:
positioning a pad in a bearing housing; and
securing the pad to the bearing housing such that a web connecting the pad to the housing at least partially resides in a receptacle in the bearing housing.

16. The method of claim 15, wherein:
the receptacle is an axial groove; and
the web is integral to at least one of the pad or the bearing housing.

17. The method of claim 15, further comprising installing a fastener to secure a root portion of the pad to the bearing housing.

18. The method of claim 15, further comprising placing a shim between the pad and the bearing housing.

19. A hydrodynamic bearing for supporting a shaft, the hydrodynamic bearing comprising:
a bearing housing defining a first surface and one or more receptacles adjoining the first surface; and
one or more pad modules, each of at least one of the one or more pad modules comprising:
a pad body;
a root portion configured to couple in at least one of the receptacles of the bearing housing; and
and an I-beam shaped web portion connecting the pad body and the root portion.

20. The hydrodynamic bearing of claim 19, wherein:
the first surface is an inner surface;
the at least one of the receptacles is configured to inhibit separation of the at least one pad module from the bearing housing; and
the hydrodynamic bearing is a tilt pad journal bearing or a tilt pad thrust bearing.
